(19) United States
(12) Patent Application Publication
(10) Pub. No.: US 2024/0340873 A1
(43) Pub. Date: Oct. 10, 2024

(54) TRAFFIC-DRIVEN BANDWIDTH PART SWITCHING AND RECEPTION

(71) Applicant: Dell Products, L.P., Round Rock, TX (US)

(72) Inventor: Ali Esswie, Calgary (CA)

(21) Appl. No.: 18/296,964

(22) Filed: Apr. 6, 2023

(51) Int. Cl. H04W 72/0453; H04W 72/232; H04W 72/543

(52) U.S. Cl. CPC H04W 72/0453; H04W 72/232; H04W 72/543

(57) ABSTRACT

A radio access node transmits to a user equipment a bandwidth part resource configuration comprising a first bandwidth part configuration to be used to receive traffic of a first flow and a second bandwidth part configuration to be used to receive traffic of a second flow, wherein the first flow and the second flow are part of a communication session. The first bandwidth part configuration may indicate a data resource of the second bandwidth part to be used by the user equipment to receive the second traffic flow. The first bandwidth part configuration may indicate to the user equipment to revert radio settings to receive traffic according to the first bandwidth part after a scheduled period of the data resource of the second bandwidth part expires. The first bandwidth part configuration may indicate a control channel resource of the second bandwidth part.

### BACKGROUND

The ‘New Radio’ (NR) terminology that is associated with fifth generation mobile wireless communication systems (“5G”) refers to technical aspects used in wireless radio access networks (“RAN”) that comprise several quality of service classes (QoS), including ultrareliable and low latency communications (“URLLC”), enhanced mobile broadband (“eMBB”), and massive machine type communication (“mMTC”). The URLLC QoS class is associated with a stringent latency requirement (e.g., low latency or low signal/message delay) and a high reliability of radio performance, while conventional eMBB use cases may be associated with high-capacity wireless communications, which may permit less stringent latency requirements (e.g., higher latency than URLLC) and less reliable radio performance as compared to URLLC. Performance requirements for mMTC may be lower than for eMBB use cases. Some use case applications involving mobile devices or mobile user equipment such as smart phones, wireless tablets, smart watches, and the like, may impose on a given RAN resource loads, or demands, that vary. A RAN node may activate a network energy saving mode to reduce power consumption.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an example embodiment, a method may comprise transmitting, by a radio access network node comprising a processor to a user equipment, a bandwidth part configuration comprising first bandwidth part resource information corresponding to a first bandwidth part and second bandwidth part resource information corresponding to a second bandwidth part. The method may comprise establishing, by the radio access network node with the user equipment, a communication session comprising a first traffic flow and a second traffic flow, wherein the establishing of the communication session comprises transmitting, by the radio access network node to the user equipment, a primary bandwidth part indication indicative to the user equipment to receive the first traffic flow according to the first bandwidth part resource information. The bandwidth part configuration may be part of a radio resource control signal message. The method may further comprise transmitting, by the radio access network node to the user equipment, first traffic, such as packets, corresponding to the first traffic flow, via a first bandwidth part data resource indicated by the first bandwidth part resource information. The method may further comprise transmitting, by the radio access network node to the user equipment, a secondary bandwidth part indication indicative to the user equipment to receive the second traffic flow according to the second bandwidth part resource information, and transmitting, by the radio access network node to the user equipment, second traffic, such as packets, corresponding to the second traffic flow, via a second bandwidth part data resource indicated by the second bandwidth part resource information.

In an embodiment, the establishing of the communication session may further comprise transmitting, by the radio access network node to the user equipment, the secondary bandwidth part indication. The second bandwidth part resource information may comprise a second bandwidth part control channel indication indicative to the user equipment of a second control channel resource corresponding to the second bandwidth part to be used to obtain control information corresponding to the second bandwidth part.

In an embodiment, the first bandwidth part resource information may comprise a first bandwidth part control channel indication indicative to the user equipment of a first control channel resource corresponding to the first bandwidth part to be used to obtain control information corresponding to the first bandwidth part. The control information corresponding to the first bandwidth part may be indicative to the user equipment of the second bandwidth part data resource. The second bandwidth part data resource may correspond to, or have, an expiration time, which may be configured via the control information, wherein the first bandwidth part control channel indication, or the control information, is indicative to the user equipment to receive traffic according to the first bandwidth part data resource after the expiration time.

In an embodiment, the control information corresponding to the first bandwidth part may be indicative to the user equipment of the second bandwidth part data resource, wherein the user equipment comprises first radio frequency circuitry and second radio frequency circuitry, wherein the radio access network node simultaneously transmits the first traffic via the first bandwidth part data resource and the second traffic via the second bandwidth part data resource.

In an embodiment, the primary bandwidth part indication and the secondary bandwidth part indication are transmitted via a downlink control information format indication message. The primary bandwidth part indication and the secondary bandwidth part indication may be indicative of at least one of a scheduled first control channel resource corresponding to the first bandwidth part or a scheduled second control channel resource corresponding to the second bandwidth part.

In an embodiment, the first traffic flow corresponds to a first quality-of-service, wherein the second traffic flow corresponds to a second quality-of-service, wherein the communication session comprises a third traffic flow corresponding to the second quality-of-service, and wherein the secondary bandwidth part indication is indicative to the user equipment to receive the third traffic flow according to the second bandwidth part resource information.

In an embodiment, arrival of protocol data units (e.g., packets) of the second traffic flow at the radio access network node may be periodic in nature and may correspond to a periodicity. The secondary bandwidth part indication may be indicative to the user equipment to switch from a first receive configuration (e.g., radio frequency receiver setup) used to receve the first traffic flow via the first bandwidth part data resource to a second receive configuation to receive the second traffic flow via the second bandwidth part data resource according to the periodicity.

In an embodiment, the first traffic flow may correspond to a first quality-of-service, the second traffic flow may correspond to a second quality-of-service, the first bandwidth part may correspond to the first quality-of-service, and the second bandwidth part may correspond to the second quality-of-service and the method may further comprise determining, based on the first traffic flow corresponding to the first quality-of-service, to transmit the first traffic flow via the first bandwidth part data resource, and determining, based on the second traffic flow corresponding to the second quality-of-service, to transmit the second traffic flow via the second bandwidth part data resource.

In an example embodiment, a radio access network node may comprise a processor configured to transmit, to a user equipment, a communication session configuration, corresponding to a communication session between the radio access network node and the user equipment. The communication session configuratoin may comprise a primary bandwidth part indication indicative of a first bandwidth part data resource, corresponding to a first bandwidth part, to be used to transmit a first traffic flow of the communication session. The communication session configuration may comprise a secondary bandwidth part indication indicative of a second bandwidth part data resource, corresponding to a second bandwidth part, to be used to transmit a second traffic flow of the communication session. The processor may be further configured to transmit, to the user equipment, the first traffic flow via the first bandwidth part data resource; and to transmit, to the user equipment, the second traffic flow via the second bandwidth part data resource.

In an embodiment, the primary bandwidth part indication is to be, or may be, indicative to the user equipment of a control channel resource corresponding to the second bandwidth part to be used to obtain control information corresponding to the second bandwidth part.

In an embodiment, the primary bandwidth part indication is to be, or may be, indicative to the user equipment of the second bandwidth part data resource. The primary bandwidth part indication is to be, or may be, indicative to the user equipment of a duration of the second bandwidth part data resource and the primary bandwidth part indication is to be, or may be, indicative to the user equipment to adjust a receive parameter (e.g., adjust a radio frequency receiver setting) according to the first bandwidth part to receive the first traffic flow, to adjust the receive parameter according to the second bandwidth part during the duration to receive the second traffic flow, and to revert the receive parameter according to, or back to, the first bandwidth part after receiving, during the duration, the second traffic flow.

In another embodiment, a non-transitory machine-readable medium, may comprise executable instructions that, when executed by a processor of a radio access network node, facilitate performance of operations, comprising receiving first traffic (e.g., packets) of a first traffic flow, corresponding to a communication session with a user equipment, to be transmitted to the user equipment. The operations may comprise receiving second traffic of a second traffic flow, corresponding to the communication session, to be transmitted to the user equipment. The operations may further comprise transmitting, to the user equipment, the first traffic via a first bandwidth part data resource, and transmitting, to the user equipment, the second traffic flow via a second bandwidth part data resource.

In an embodiment, the operations may further comprise transmitting, to the user equipment, a communication session configuration, corresponding to the communication session, comprising a primary bandwidth part indication indicative of the first bandwidth part data resource and a secondary bandwidth part indication indicative of the second bandwidth part data resource. The primary bandwidth part indication may be indicative of a start time of the second bandwidth part data resource.

In an embodiment, the operations may further comprise transmitting, to the user equipment, a communication session configuration, corresponding to the communication session, comprising a primary bandwidth part indication indicative of the first bandwidth part data resource and a secondary bandwidth part indication indicative of the second bandwidth part data resource. The primary bandwidth part indication may be indicative of a control channel resource corresponding to the second bandwidth part to be used to obtain control information corresponding to the second bandwidth part.

In an embodiment, the operations may further comprise transmitting, to the user equipment, a communication session configuration, corresponding to the communication session, comprising a primary bandwidth part indication indicative of the first bandwidth part data resource and a secondary bandwidth part indication indicative of the second bandwidth part data resource. The primary bandwidth part indication may be indicative of a duration of the second bandwidth part data resource. The primary bandwidth part indication may be indicative to the user equipment to adjust a receive parameter according to the first bandwidth part to receive the first traffic flow, to adjust the receive parameter according to the second bandwidth part during the duration to receive the second traffic flow, and to revert the receive parameter according to the first bandwidth part after receiving, during the duration, the second traffic flow. The radio access network node may transmit the second traffic flow during the duration of the second bandwidth part data resource.

### BRIEF DESCRIPTION OF THE DRAWINGS

FIG. 1 illustrates wireless communication system environment.

FIG. 2 illustrates an example virtual reality appliance.

FIG. 3 illustrates example primary and secondary bandwidth parts to transmit one or more traffic flows of a communication session to a user equipment.

FIG. 4 illustrates an example radio resource control signal configuration message.

FIG. 5 illustrates an example downlink control information configuration message.

FIG. 6A illustrates example primary and secondary bandwidth parts to transmit one or more traffic flows of a communication session to a user equipment that monitors a control channel resource corresponding to the first bandwidth part to obtain indication of scheduled data resources corresponding to the secondary bandwidth part.

FIG. 6B illustrates example primary and secondary bandwidth parts to transmit one or more traffic flows of a communication session to a user equipment that monitors control channel resources of the primary and secondary bandwidth parts.

FIG. 6C illustrates example bandwidth parts to transmit one or more traffic flows of a communication session to a user equipment having multiple radio frequency circuitry chains.

FIG. 7 illustrates a timing diagram of an example embodiment of using multiple bandwidth parts to transmit one or traffic flows of a communication session.

FIG. 8 illustrates a flow diagram of an example embodiment method of using multiple bandwidth parts to transmit traffic of a communication session.

FIG. 9 illustrates a block diagram of an example method embodiment.

FIG. 10 illustrates a block diagram of an example radio access network node.

FIG. 11 illustrates a block diagram of an example non-transitory machine-readable medium embodiment.

FIG. 12 illustrates an example computer environment.

FIG. 13 illustrates a block diagram of an example wireless user equipment.

### DETAILED DESCRIPTION OF THE DRAWINGS

As a preliminary matter, it will be readily understood by those persons skilled in the art that the present embodiments are susceptible of broad utility and application. Many methods, embodiments, and adaptations of the present application other than those herein described as well as many variations, modifications and equivalent arrangements, will be apparent from or reasonably suggested by the substance or scope of the various embodiments of the present application.

Accordingly, while the present application has been described herein in detail in relation to various embodiments, it is to be understood that this disclosure is illustrative of one or more concepts expressed by the various example embodiments and is made merely for the purposes of providing a full and enabling disclosure. The following disclosure is not intended nor is to be construed to limit the present application or otherwise exclude any such other embodiments, adaptations, variations, modifications and equivalent arrangements, the present embodiments described herein being limited only by the claims appended hereto and the equivalents thereof.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. In yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

As an example use case that illustrates example embodiments disclosed herein, Virtual Reality (“VR”) applications and VR variants, (e.g., mixed and augmented reality) may at some time perform best when using NR radio resources associated with URLLC while at other times lower performance levels may suffice. A virtual reality smart glass device may consume NR radio resources at a given broadband data rate having more stringent radio latency and reliability criteria to provide a satisfactory end-user experience.

5G systems should support ‘anything reality’ (“XR”) services. XR services may comprise VR applications, which are widely adopted XR applications that provide an immersive environment which can stimulate the senses of an end user such that he, or she, may be ‘tricked’ into the feeling of being within a different environment than he, or she, is actually in. XR services may comprise Augmented Reality (‘AR’) applications that may enhance a real-world environment by providing additional virtual world elements via a user's senses that focus on real-world elements in the user's actual surrounding environment. XR services may comprise Mixed reality cases (“MR”) applications that help merge, or bring together, virtual and real worlds such that an end-user of XR services interacts with elements of his, or her, real environment and virtual environment simultaneously.

Different XR use cases may be associated with certain radio performance targets. Common to XR cases, and unlike URLLC or cMBB, high-capacity links with stringent radio and reliability levels are typically needed for a satisfactory end user experience. For instance, compared to 5 Mbps URLLC link with a 1 ms radio budget, some XR applications need 100 Mbps links with a couple of milliseconds of allowed radio latency. Thus, 5G radio design and associated procedures may be adapted to the new XR QoS class and associated performance targets.

An XR service may be facilitated by traffic having certain characteristics associated with the XR service. For example, XR traffic may typically be periodic with time-varying packet size and packet arrival rate. In addition, different packet traffic flows of a single XR communication session may affect an end user's experience differently. For instance, a smart glass that is streaming 180-degree high-resolution frames may use a large percentage of a broadband service's capacity for fulfilling user experience. However, frames that are to be presented to a user's pose direction (e.g., front direction) are the most vital for an end user's satisfactory user experience while frames to be presented to a user's periphery vision have less of an impact on a user's experience and thus may be associated with a lower QoS requirement for transport of traffic packets as compared to a QoS requirement for transporting the pose-direction traffic flow. Therefore, flow differentiation that prioritizes some flows, or some packets, of a XR session over other flows or packets may facilitate efficient use of a communication system's capacity to deliver the traffic. Furthermore, XR capable devices (e.g., smart glasses, projection wearables, etc.) may be more power-limited than conventional mobile handsets due to the limited form factor of the devices. Thus, techniques to maximize power saving operation at XR capable device is desirable. Accordingly, a user equipment device accessing XR services, or traffic flows of an XR session, may be associated with certain QoS metrics to satisfy performance targets of the XR service in terms of perceived data rate or end to end latency and reliability, for example.

High-capacity-demanding services, such as virtual reality applications, may present performance challenges to even 5G NR capabilities. Thus, even though 5G NR systems may facilitate and support higher performance capabilities, the radio interface should nevertheless be optimized to support extreme high capacity and low latency requirements of XR applications and XR data traffic.

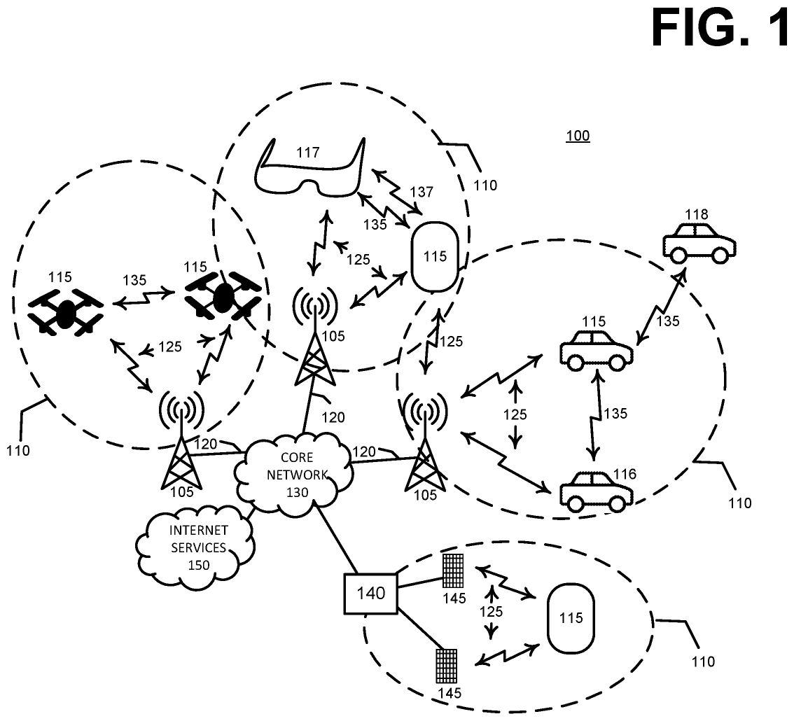

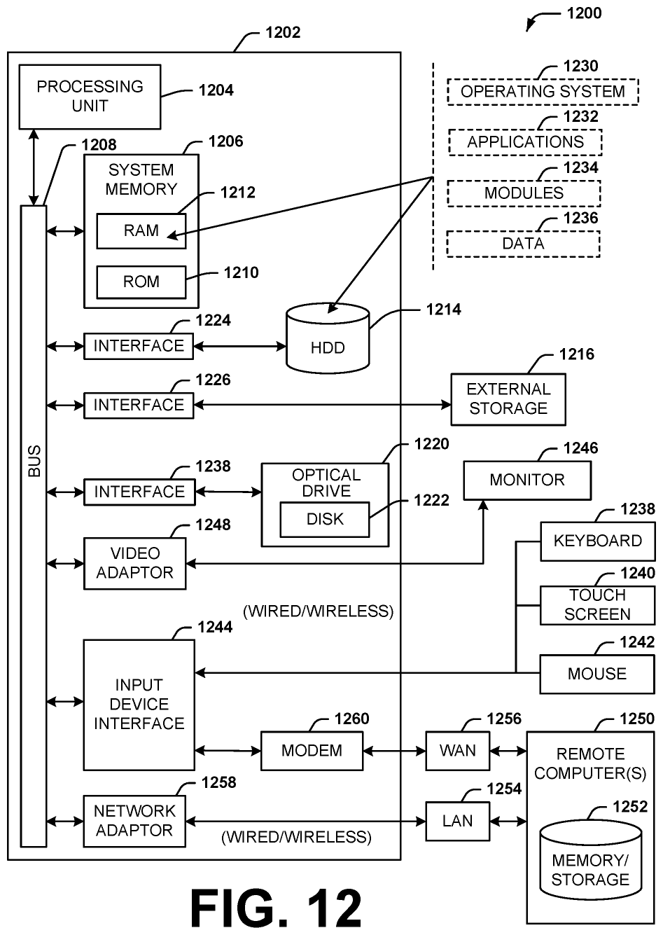

Turning now to the figures, FIG. 1 illustrates an example of a wireless communication system 100 that supports blind decoding of PDCCH candidates or search spaces in accordance with one or more example embodiments of the present disclosure. The wireless communication system 100 may include one or more base stations 105, one or more user equipment (“UE”) devices 115, and core network 130. In some examples, the wireless communication system 100 may comprise a long-range wireless communication network, that comprises, for example, a Long-Term Evolution (LTE) network, an LTE-Advanced (LTE-A) network, an LTE-A Pro network, or a New Radio (NR) network. In some examples, the wireless communication system 100 may support enhanced broadband communications, ultra-reliable (e.g., mission critical) communications, low latency communications, communications with low-cost and low-complexity devices, or any combination thereof. As shown in the figure, examples of UEs 115 may include smart phones, automobiles or other vehicles, or drones or other aircraft. Another example of a UE may be a virtual reality appliance 117, such as smart glasses, a virtual reality headset, an augmented reality headset, and other similar devices that may provide images, video, audio, touch sensation, taste, or smell sensation to a wearer. A UE, such as VR appliance 117, may transmit or receive wireless signals with a RAN base station 105 via a long-range wireless link 125, or the UE/VR appliance may receive or transmit wireless signals via a short-range wireless link 137, which may comprise a wireless link with a UE device 115, such as a Bluetooth link, a Wi-Fi link, and the like. A UE, such as appliance 117, may simultaneously communicate via multiple wireless links, such as over a link 125 with a base station 105 and over a short-range wireless link. VR appliance 117 may also communicate with a wireless UE via a cable, or other wired connection. A RAN, or a component thereof, may be implemented by one or more computer components that may be described in reference to FIG. 12.

Continuing with discussion of FIG. 1, base stations 105 may be dispersed throughout a geographic area to form the wireless communication system 100 and may be devices in different forms or having different capabilities. The base stations 105 and the UEs 115 may wirelessly communicate via one or more communication links 125. Each base station 105 may provide a coverage area 110 over which UEs 115 and the base station 105 may establish one or more communication links 125. Coverage area 110 may be an example of a geographic area over which a base station 105 and a UE 115 may support the communication of signals according to one or more radio access technologies.

UEs 115 may be dispersed throughout a coverage area 110 of the wireless communication system 100, and each UE 115 may be stationary, or mobile, or both at different times. UEs 115 may be devices in different forms or having different capabilities. Some example UEs 115 are illustrated in FIG. 1. UEs 115 described herein may be able to communicate with various types of devices, such as other UEs 115, base stations 105, or network equipment (e.g., core network nodes, relay devices, integrated access and backhaul (IAB) nodes, or other network equipment), as shown in FIG. 1.

Base stations 105 may communicate with the core network 130, or with one another, or both. For example, base stations 105 may interface with core network 130 through one or more backhaul links 120 (e.g., via an S1, N2, N3, or other interface). Base stations 105 may communicate with one another over the backhaul links 120 (e.g., via an X2. Xn, or other interface) either directly (e.g., directly between base stations 105), or indirectly (e.g., via core network 130), or both. In some examples, backhaul links 120 may comprise one or more wireless links.

One or more of base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a bNodeB or gNB), a Home NodeB, a Home cNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, a personal computer, or a router. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or smart meters, among other examples.

UEs 115 may be able to communicate with various types of devices, such as other UEs 115 that may sometimes act as relays as well as base stations 105 and the network equipment including macro eNBs or gNBs, small cell eNBs or gNBs, or relay base stations, among other examples, as shown in FIG. 1.

UEs 115 and base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. Wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by UEs 115. A carrier may be operated in a standalone mode where initial acquisition and connection may be conducted by UEs 115 via the carrier, or the carrier may be operated in a non-standalone mode where a connection is anchored using a different carrier (e.g., of the same or a different radio access technology).

Communication links 125 shown in wireless communication system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications e.g., in a TDD mode).

A carrier may be associated with a particular bandwidth of the radio frequency spectrum, and in some examples the carrier bandwidth may be referred to as a “system bandwidth” of the carrier or the wireless communication system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communication system 100 (e.g., the base stations 105, the UEs 115, or both) may have hardware configurations that support communications over a particular carrier bandwidth or may be configurable to support communications over one of a set of carrier bandwidths. In some examples, the wireless communication system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE. A wireless communications resource may refer to a combination of a radio frequency spectrum resource, a time resource (e.g., a search space), or a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for a UE 115 may be restricted to one or more active BWPs.

The time intervals for base stations 105 or UEs 115 may be expressed in multiples of a basic time unit which may, for example, refer to a sampling period of Ts=1/(Afmax. Nf) seconds, where Afmax may represent the maximum supported subcarrier spacing, and Nr may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods e.g., depending on the length of the cyclic prefix prepended to each symbol period). In some wireless communication systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communication system 100 and may be referred to as a transmission time interval (TTI). In some examples, the TTI duration (e.g., the number of symbol periods in a TTI) may be variable. Additionally, or alternatively, the smallest scheduling unit of the wireless communication system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of UEs 115. For example, one or more of

UEs 115 may monitor or search control regions, or spaces, for control information according to one or more search space sets, and each search space set may include one or multiple control channel candidates in one or more aggregation levels arranged in a cascaded manner. An aggregation level for a control channel candidate may refer to a number of control channel resources (e.g., control channel clements (CCEs)) associated with encoded information for a control information format having a given payload size. Search space sets may include common search space sets configured for sending control information to multiple UEs 115 and UE-specific search space sets for sending control information to a specific UE 115. Other search spaces and configurations for monitoring and decoding them are disclosed herein that are novel and not conventional.

A base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage arca 110 or a portion of a geographic coverage area 110 (e.g., a sector) over which the logical communication entity operates. Such cells may range from smaller arcas (e.g., a structure, a subset of structure) to larger areas depending on various factors such as the capabilities of a base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., UEs 115 in a closed subscriber group (CSG), UEs 115 associated with users in a home or office). A base station 105 may support one or multiple cells and may also support communications over the one or more cells using one component carrier, or multiple component carriers.

In some examples, a carrier may support multiple cells, and different cells may be configured according to different protocol types (e.g., MTC, narrowband IoT (NB-IoT), enhanced mobile broadband (cMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communication system 100 may include, for example, a heterogeneous network in which different types of the base stations 105 provide coverage for various geographic coverage areas 110 using the same or different radio access technologies.

The wireless communication system 100 may support synchronous or asynchronous operation. For synchronous operation, the base stations 105 may have similar frame timings, and transmissions from different base stations 105 may be approximately aligned in time. For asynchronous operation, base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communication system 100 may be configured to support ultra-reliable communications or low-latency communications, or various combinations thereof. For example, the wireless communication system 100 may be configured to support ultra-reliable low-latency communications (URLLC) or mission critical communications. UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). Communication link 135 may comprise a sidelink communication link. One or more UEs 115 utilizing D2D communications, such as sidelink communication, may be within the geographic coverage area 110 of a base station 105. Other UEs 115 in such a group may be outside the geographic coverage area 110 of a base station 105 or be otherwise unable to receive transmissions from a base station 105. In some examples, groups of UEs 115 communicating via D2D communications may utilize a one-to-many (1: M) system in which a UE transmits to every other UE in the group. In some examples, a base station 105 facilitates the scheduling of resources for D2D communications. In other cases, D2D communications are carried out between UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more RAN network nodes (e.g., base stations 105) using vehicle-to-network (V2N) communications, or with both. In FIG. 1, vehicle UE 116 is shown inside a RAN coverage area and vehicle UE 118 is shown outside the coverage area of the same RAN. Vehicle

UE 115 wirelessly connected to the RAN may be a sidelink relay to in-RAN-coverage-range vehicle UE 116 or to out-of-RAN-coverage-range vehicle UE 118.

The core network 130 may provide user authentication, access authorization, tracking. Internet Protocol (IP) connectivity, and other access, routing, or mobility functions. Core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for UEs 115 that are served by the base stations 105 associated with core network 130. User IP packets may be transferred through the user plane entity, which may provide IP address allocation as well as other functions. The user plane entity may be connected to IP services 150 for one or more network operators. IP services 150 may comprise access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices e.g., radio heads and ANCs) or consolidated into a single network device (e.g., a base station 105).

The wireless communication system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHZ.

The wireless communication system 100 may also operate in a super high frequency (SHF) region using frequency bands from 3 GHZ to 30 GHZ, also known as the centimeter band, or in an extremely high frequency (EHF) region of the spectrum (e.g., from 30 GHz to 300 GHz), also known as the millimeter band. In some examples, the wireless communication system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communication system 100 may utilize both licensed and unlicensed radio frequency spectrum bands. For example, the wireless communication system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as base stations 105 and UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Base stations 105 or UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, a base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by a base station 105 in different directions and may report to the base station an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). A UE 115 may report feedback that indicates precoding weights for one or more beam directions, and the feedback may correspond to a configured number of beams across a system bandwidth or one or more sub-bands. A base station 105 may transmit a reference signal (e.g., a cell-specific reference signal (CRS), a channel state information reference signal (CSI-RS)), which may be precoded or unprecoded. A UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communication system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

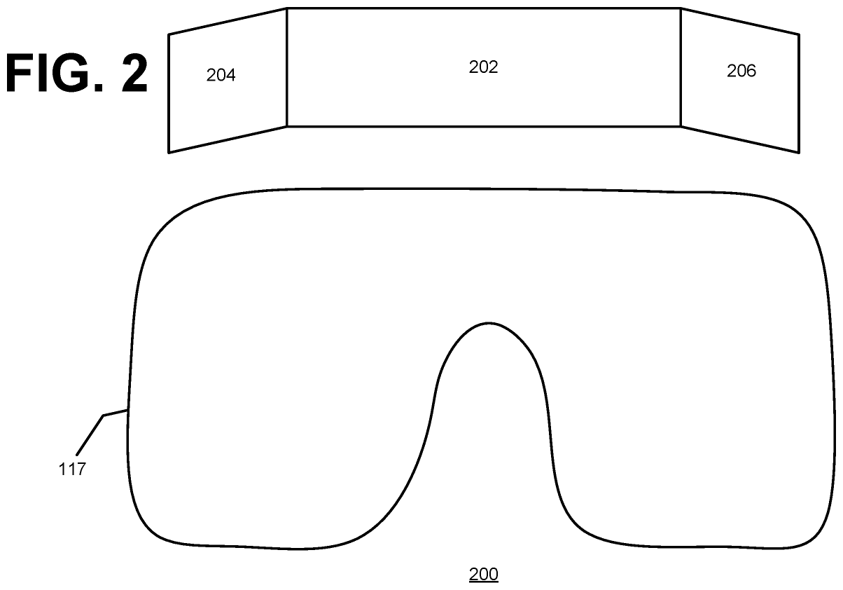

Turning now to FIG. 2, the figure illustrates a virtual reality (“VR”) application system 200. In system 200, wearable VR appliance 117 is shown from a wearer's, or viewer's, perspective. VR appliance 117 may comprise a center, or pose, visual display portion 202, a left visual display portion 204 and a right visual display portion 206, that may be used to display main visual information, left peripheral visual information, and right peripheral visual information, respectively. As shown in the figure, the portions 202, 204, and 206 are delineated by distinct lines, but it will be appreciated that hardware or software may facilitate gradual transition from main and peripheral information display.

As discussed above, different XR use cases may require different corresponding radio performance. Typically, for XR use cases but unlike for URLLC or eMBB use cases, high-capacity radio links that carry XR data traffic (e.g., data flows that comprise visual information) with stringent radio levels (e.g . . . latency) and reliability levels are required for a reasonable end user experience. For example, compared to 5 Mbps URLLC link with a 1 ms radio latency budget, some XR applications require 100 Mbps links with about 2 mS allowed radio latency.

From research, several characteristics have been determined that for XR data traffic: (1) XR traffic characteristics are typically periodic with time-varying packet size and packet arrival rate; (2) XR capable devices may be more power-limited than conventional mobile handsets, (e.g., smart glasses, projection wearables, etc.) due to the limited form factor of the devices; (3) multiple data packet flows corresponding to different visual information of a given XR session are not perceived by a user as having the same impact on the end user experience.

Thus, in addition to needing XR-specific power use efficiency, smart glasses, such as wearable appliance 117, streaming 180-degree high-resolution frames requires broadband capacity for providing an optimum user experience. However, it has been determined that data corresponding to the frames that carry main, or center visual information (i.e., the pose or front direction) are the most vital for end user satisfaction, while the frames corresponding to peripheral visual information have a lesser impact on a user's experience. Therefore, accepting higher latency for less important traffic flows so that resources that would otherwise be allocated to the less important traffic flows can be used for traffic flows corresponding to more important traffic, or to devices that carry the more important traffic, may be used to optimize overall capacity and performance of a wireless communication system, such as a 5-G communication system using NR techniques, method, systems, or devices. For example, a wireless data traffic flow carrying visual information for display on center, or pose, visual display portion 202 may be prioritized higher than a wireless data traffic flow carrying visual information for left visual display portion 204 or for right visual display portion 206.

The performance of a communication network in providing an XR services may be at least partially determined according to satisfaction of a user of the XR services. Each XR-service-using user device may be associated with certain QoS metrics to satisfy the performance targets of the user's service, in terms of perceived data rate, end-to-end latency, and reliability.

A 5G NR radio system typically comprises a physical downlink control channel (“PDCCH”), which may be used to deliver downlink and uplink control information to cellular devices. The 5G control channel may facilitate operation according to requirements of URLLC and eMBB use cases and may facilitate an efficient coexistence between such different Qos classes.

Bandwidth split into parts.

A radio access network, comprising, for example, a 5G NR network node, may be implement Bandwidth Part (“BWP”) technology. BWP technology may be implemented by dividing a range of frequencies, or bandwidth, that has been assigned to, or allocated to, a carrier, a gNode B, or a carrier's signaling from and to a gNodeB, into multiple smaller bandwidth subsets, or frequency subranges, such that a subset, or subrange, may be ‘seen’ as a whole communication bandwidth that can be used by a user equipment for communication with a gNodeB/RAN node. From a user equipment perspective, a single configured BWP may be considered the whole available RAN/cell bandwidth, which includes frequency and time resources for data, control, and reference signals. For example, an available bandwidth of 100 MHz may be divided into ten smaller subsets, or subranges, of 10 MHZ, with each 10 MHZ subrange being referred to as a bandwidth part. A RAN node can configure multiple BWPs for use by different active user equipment devices, or different groups of user equipment devices, with each BWP being used to support radio characteristics corresponding to the BWP, the characteristics including bandwidth level, subcarrier spacing or supported antenna modes. As currently implemented, RAN node may typically configure up to four different BWPs, each having resources facilitating communication in the downlink and uplink directions. However, only a single BWP can be active at a time. This limitation is imposed due to limited processing capabilities of both the network and user equipment devices simultaneously monitoring and receiving multiple BWPs of different radio characteristics.

BWP technology may facilitate performance benefits, such as, for example power saving gain by a user equipment that may be realized by the user equipment scanning. monitoring, or decoding the smaller bandwidth range of the BWP instead of scanning, monitoring, and decoding the larger whole cell bandwidth that may be allocated to a mobile network operator (“MNO”)/carrier with which the user equipment has been provisioned for operation. In other words, a user equipment may be configured to tune its radio functions to communicate with a RAN node using frequency and time resources of a BWP, thus the user equipment may not expend processing resources or power resources in scanning the entire range of frequencies allocated to the MNO/carrier. User equipment devices are typically configured to always scan a configured available frequency range/bandwidth for multiple reasons including maintaining synchronization with the RAN node radio interface and to periodically check the user equipment device is camped on the best possible cell/RAN node, or beam thereof, with respect to signal strength coverage. The spectrum of frequencies that may be used for 5G NR communication is significantly greater than a spectrum allocated for, and used by, older mobile communication generations (e.g., LTE, 4G, 3G, etc.), and a frequency range, or spectrum, allocated to a given MNO/carrier for 5G NR operation can span hundreds of MHz. Having to scan an entire 5G NR MNO range by a user equipment would impose a severe processing load on a user equipment device. Thus, having a smaller-sized BWP configured for user equipment facilitates a user equipment device having reduced processing load by only scanning the bandwidth of the configured BWP instead of the entire bandwidth allocated to the MNO/carrier for which the user equipment is configured. Regarding grouping, user equipment devices can be grouped and configured, for example, with the same BWP based on having common quality of service requirements. Accordingly, a BWP configured for a group can be configured with radio aspects and radio resources that are suitable for performance requirements common to devices of the group. For example, a BWP, serving latency-critical devices, is likely to be configured with a larger subcarrier spacing to allow for faster transmissions.

Another benefit of implementing BWP technology is that user equipment devices may be grouped into sets of user equipment devices that share configured BWP resources based on quality-of-service requirements or functionalities that are common among the user equipment devices that are members of the set, or group, of user equipment. A RAN node may configure multiple BWPs with corresponding different radio resource setups, or arrangements.

According to existing bandwidth part techniques, only a single BWP can be actively configured for a user equipment device at a time. Thus, a user equipment expects to receive radio signals and data from the serving cell according to the single BWP. For example, user equipment devices receiving critical traffic can be assigned a stringent BWP (e.g., a BWP configured with large subcarrier spacing, advanced MIMO transmissions, mini-slot scheduling trading off the increased control overhead for faster radio transmissions, etc.) while user equipment receiving best effort traffic can be grouped to receive traffic according to a best effort BWP (e.g., a BWP having longer transmission periodicity, and advanced device multiplexing techniques trading off the degraded radio latency and reliability for boosted BWP capacity, etc.), thus maximizing the over network capacity.

However, for use cases, such as XR services, traffic is composed of multiple flows having different performance targets. For example, for XR view-port dependent streaming. an XR video streaming traffic session has a pose traffic flow (with packets feeding the pose direction of VR appliance, for example) with very stringent latency and reliability target compared to other traffic flows carrying traffic for peripheral/side positions of a VR appliance (e.g., a flow with packets feeding edges to facilitate the immersive viewing experience), and which may have relaxed latency and reliability requirement compared to a traffic flow carrying packets directed to a pose portion of a VR appliance due to human nature observing delays and packet drops in a pose portion more than in edge portions of an appliance. Thus, according to existing BWP techniques, both traffic flow types are handled within the same stringent BWP since a device can be only assigned a single active BWP at a time for a single active communication session. This results in the best effort traffic corresponding to, for example, a peripheral portion of a VR appliance, being transmitted according to a conservative, highly reliable and low latency treatment which is unnecessary and results in inefficient use of spectral resources of the BWP. Accordingly, embodiments disclosed herein may facilitate a radio access network node dynamically schedule user equipment devices with resources corresponding to multiple BWPs for the same communication session, with each BWP carrying a traffic flow of a certain importance or criticality level that is efficiently accommodated by radio configurations according to the BWP. Novel radio signaling procedures may facilitate cross-BWP scheduling and dynamic switching.

As discussed, with existing BWP techniques, a single active BWP is configured for a user equipment at a time. Thus, for a multi-flow XR traffic session, all traffic flows of the session are received according to the same configured BWP, which may result in receiving critical flows via a best effort BWP or receiving best effort flows via a BWP designed to accommodate a critical-level QoS, which would result in degrading radio latency, reliability, and capacity for the critical QoS flow(s). Accordingly, embodiments disclosed herein enable user equipment to receive certain traffic flows via a certain BWP and other traffic flows via another BWP, wherein design of the BWPs is suitable for radio and QoS requirements of the flows that they are designed to carry.

According to existing BWP control signaling techniques, a single control channel instant can only carry scheduling or control information for the active BWP. Embodiments disclosed herein facilitate a single control channel carrying, or comprising, control and scheduling information for primary and secondary BWPs at the same time. Including control and scheduling information for more than one BWP in a control channel may facilitate user equipment avoid battery-non-friendly blind decoding of an independent control channel occasion associated with each BWP. Thus, user equipment devices avoid performing blind decoding of multiple control channels with different radio transmission configurations.

Traffic-driven bandwidth part (BWP) switching and reception.

Unlike existing BWP techniques, where all traffic flows of a single device session must be received according to the same BWP, embodiments disclosed herein enable devices to receive stringent traffic flows according to conservative decoding via stringent BWPs while receiving best effort flows over best effort or packet-loss-tolerant BWPs. Thus, overall network spectral efficiency user equipment power saving is increased or maximized. User equipment power saving may result from a user equipment offloading reception of best effort traffic, for example, to reception capabilities (e.g., receiving payload on a longer periodicity, activating lower number of antennas, etc.) conducive to receiving best effort traffic flows on less capable BWPs. Therefore, according to embodiments disclosed herein, a radio access network node may configure user equipment that are receiving, or are requesting to receive, multi-priority traffic flows of a session with a primary BWP and with one or more secondary BWPs.

The primary BWP may be monitored, e.g., repeatedly or continuously, for resource scheduling information corresponding to the primary BWP. The primary BWP may be monitored for resource scheduling information corresponding to one or more secondary BWPs as well, which may be referred to as cross-BWP scheduling for a session. Specifically, a RAN node may configure UE devices with a primary BWP that is associated with receiving traffic flows corresponding to certain traffic flow identifiers or data radio bearers according to certain critical radio requirements specified by a primary BWP configuration corresponding to stringent BWP radio setup (e.g., advanced antenna setup, mini-slot fast transmission, highly reliable control channel transmissions, etc.). Using a primary BWP to facilitate stringent quality requirement may trade RAN node or UE device power saving and network capacity in exchange for highly reliable and ultra-low latency transmission via the primary BWP. The UE may be configured to concurrently, e.g., simultaneously, receive best effort traffic flows requiring only best effort radio performance via one or more secondary BWPs that may specify relaxed latency, reliability, or power consumption procedures, including relaxed MIMO capability, longer transmission, less conservative transmissions, etc., relative to radio setting specified by the primary BWP. Thus, for example, for an XR multi-flow device session, stringent XR flows can be reliably served within a URLLC configured primary BWP while the XR best effort flows may be transmitted over a best effort eMBB secondary BWP. Embodiments disclosed herein may a facilitate a single control channel information in the primary BWP comprising indication of scheduling of resources for the primary BWP and the secondary BWP(s). Including resource scheduling information corresponding to both primary and secondary BWPs in a single control information message may facilitate a UE in avoiding blind decoding a control channel for each configured BWP, thus reducing power consumption at the UE. Embodiment disclosed herein may comprise novel control channel format or control signaling.

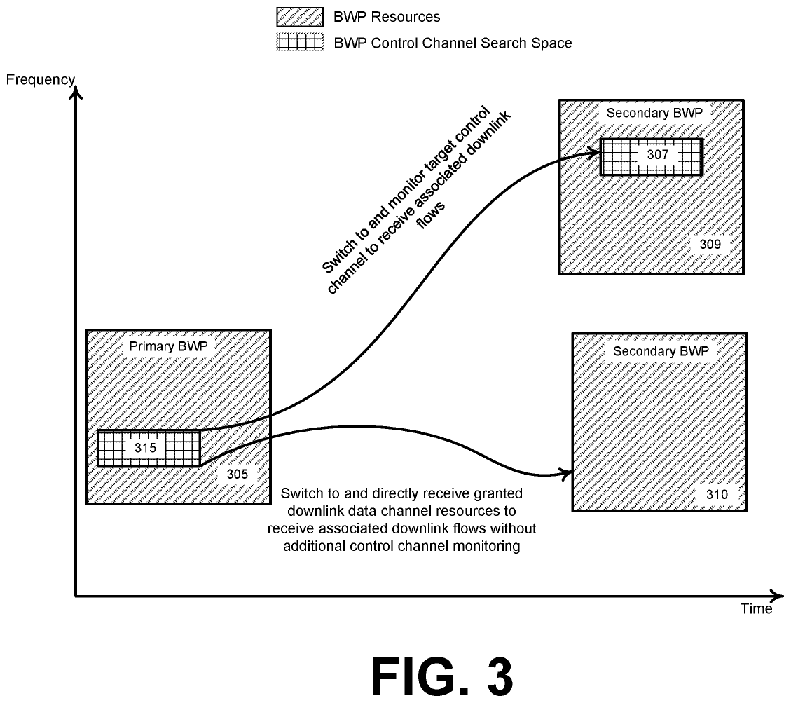

Turning now to FIG. 3, illustrates an example embodiment 300 with a primary BWP 305 being configured for continuous monitoring, and being associated with receiving certain stringent traffic flows according to respective traffic flow identifiers, data radio bearers (“DRB”), or traffic priority levels. Thus, primary BWP 305 may be configured to support critical traffic with tight latency and reliability and latency performance QoS targets. Therefore, primary BWP 305 may be designed to trade off offered capacity in exchange for optimized latency and reliability, incorporating larger subcarrier spacing, advanced MIMO capability, and faster scheduling. Furthermore, a user equipment may be configured to use secondary BWPs 310 may to receive less stringent traffic flows and may be associated with certain flow identifiers or DRB identifiers. A RAN may assign secondary BWP 310 that may trade off latency and reliability in exchange for boosted BWP capacity relative to primary BWP 305. Thus, BWP 310 may be configured with lower subcarrier spacings, longer scheduling periodicity and less conservative control channel coding/decoding. A radio access network node can dynamically schedule resources, corresponding to primary BWP 305 and secondary BWP 310 simultaneously from information contained in the control channel 315 of the primary BWP. Thus, using the embodiment shown in FIG. 3, user equipment devices may only need to blindly decode single control channel 315 of the primary BWP 305 to extract resource scheduling information corresponding to configured resources of the primary BWP and of secondary BWP 310. Such use of control channel resource 315 to not only apprise a user equipment of scheduled resources corresponding to BWP 305 but also to apprise the UE of scheduled resources corresponding to BWP 310, may reduce power consumption by a user equipment due to avoiding blind decoding of multiple control channels.

To facilitate using a control channel resource corresponding to primary BWP 305 to indicate scheduled resources corresponding to secondary BWP 310, a change to existing downlink control information (DCI) signaling may be implemented as disclosed herein to indicate resource scheduling information corresponding to the secondary BWP being contained in, or indicated by, information contained in a control channel corresponding to primary BWP 305.

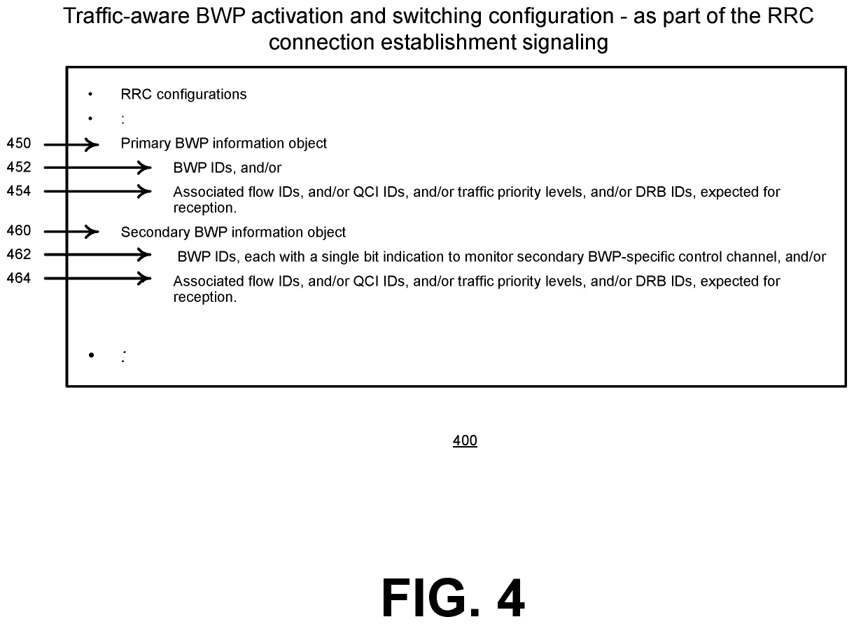

In another embodiment, via control channel signaling updates, a user equipment may be configured to switch to a target secondary BWP to receive traffic flows associated with the secondary BWP without the control channel of the primary BWP indicating the scheduled resource information corresponding to the secondary BWP. A user equipment may switch to a target secondary BWP, first monitor and attempt blind decoding of a secondary BWP control channel to determine resource scheduling information corresponding to the secondary BWP. As shown in FIG. 4, radio resource control (“RRC”) configuration signaling message 400 may configure a user equipment device with primary BWP information object 450 and with secondary BWP information object 460 to receive multiple traffic flows of various criticality corresponding to various QoS profiles, corresponding to the same communication session. Primary BWP information object 450 may comprise primary BWP identifier 452 and may comprise flow identifier 454 indicative of a traffic flow to be transmitted via resources corresponding to a BWP corresponding to BWP identifier 452. Primary BWP information object 450 may comprise QCI indication 457, priority level indication 458, or data radio bearer identifier 459 to be used for reception of a flow corresponding to flow identifier 454.

Secondary BWP information object 460 may comprise secondary BWP identifier 462 and may comprise flow identifier 464 indicative of a traffic flow to be transmitted via resources corresponding to a BWP associated with BWP identifier 462. Secondary BWP information object 460 may comprise QCI indication 467, priority level indication 468, or data radio bearer identifier 469 to be used for reception of a flow corresponding to flow identifier 464. One or more secondary BWP identifiers 462 may be signaled for transmitting one or more best effort traffic flows. A secondary BWP 462 may comprise a single bit secondary control channel indication indicative of whether a user equipment, in switching from a primary BWP to a secondary BWP, needs to monitor and blindly decode a control channel corresponding to the secondary BWP in an embodiment in which a control channel of the primary BWP does not comprise an indication of resource grant information corresponding to the secondary BWP(s).

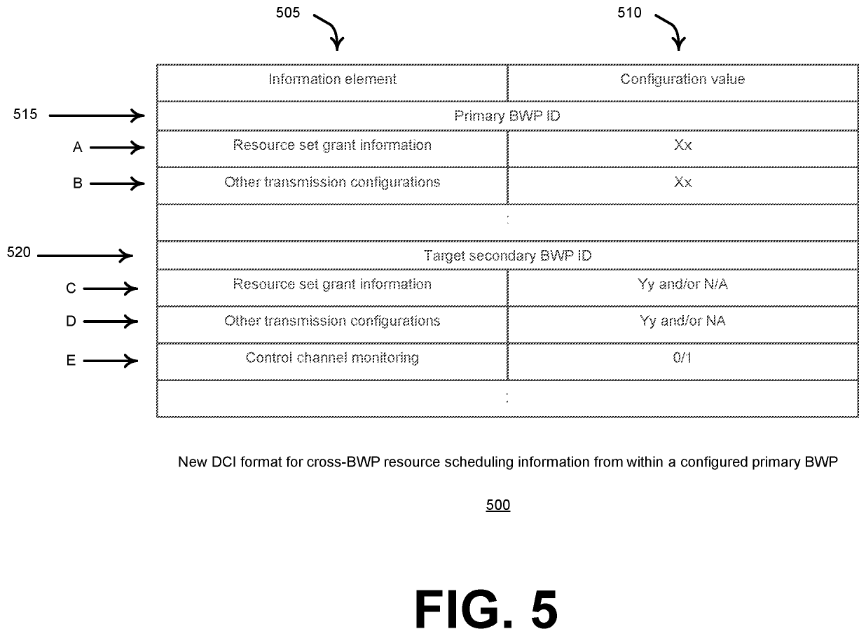

A new DCI format 500, e.g., control format and/or message format, shown in FIG. 5 may be used to indicate in a control channel corresponding to primary BWP 305 scheduling of resources for primary and secondary BWPs, which may facilitate a user equipment avoiding monitoring and having to blindly decode control channels of a secondary BWP, for example BWP 310, or a primary BWP, for example BWP 305. New DCI format 500 may contain resource scheduling information and transmission configuration in the form of multiple information objects with each being associated with a certain BWP identifier (corresponding to a primary BWP or a secondary BWP). Thus, a user equipment may determine when to switch to a secondary BWP to receive payload via a given traffic flow and may begin receiving the traffic without monitoring a control channel of the secondary BWP.

DCI format 500 may comprise an information element field 505 and a configuration value field 510. DCI format 500 may comprise a primary BWP identifier 515. Corresponding to primary BWP identifier 515, DCI format 500 may comprise a resource grant indication shown in cell 505A (row A in field 505) and a value, such as a timing or frequency value, in cell 510A. Also corresponding to primary BWP identifier 515, DCI format 500 may comprise indication of other configuration parameter(s) in cell 505B and a corresponding value in cell 510B. DCI format 500 may comprise a secondary BWP identifier 520. Corresponding to secondary BWP identifier 520, DCI format 500 may comprise a resource grant indication shown in cell 505C and a value, such as a timing or frequency value, in cell 510C. Also corresponding to secondary BWP identifier 520, DCI format 500 may comprise indication of other configuration parameter(s) in cell 505D and a corresponding value in cell 510D. Also corresponding to secondary BWP identifier 520, DCI format 500 may comprise a control channel monitoring indication cell 505E and a corresponding indication value, which may be a single-bit field (e.g., the value in cell 510E of DCI format 500 may be either a ‘l’ or a ‘0’.) As an example, a value of ‘1’ transmitted in cell 510E may be indicative that a user equipment that has received DCI format 500 needs to monitor a control channel of secondary BWP corresponding to BWP identifier 520 to determine resource grants, whereas a ‘0’ transmitted in cell 510E may be indicative that resources indicated in cell 510C or 510D may be monitored without having to monitor and decode a control channel corresponding to the secondary BWP.

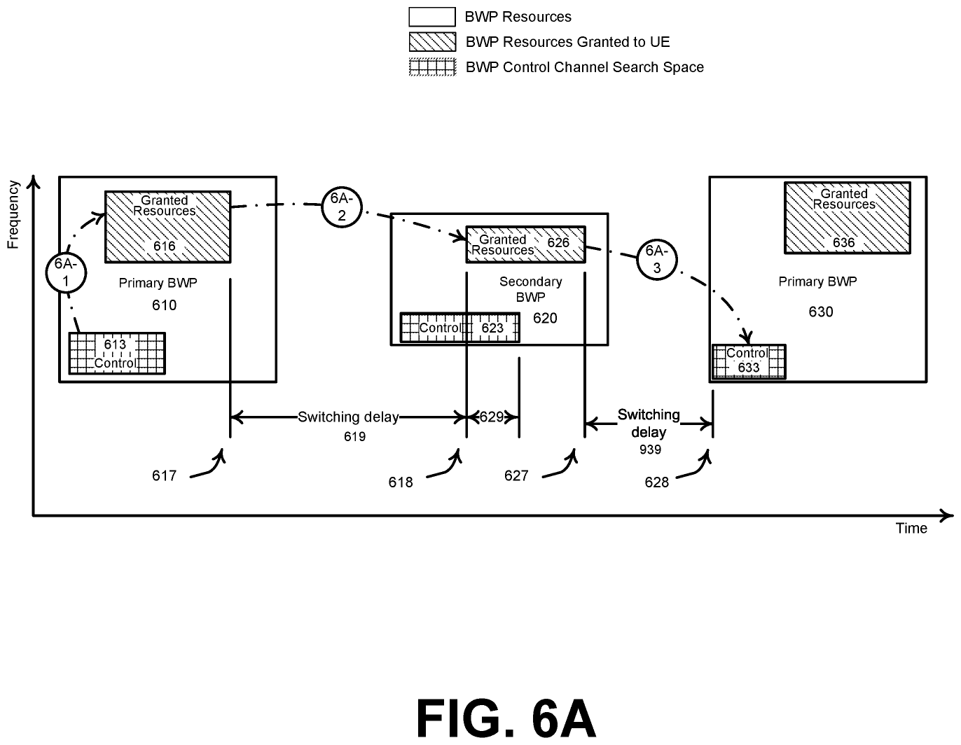

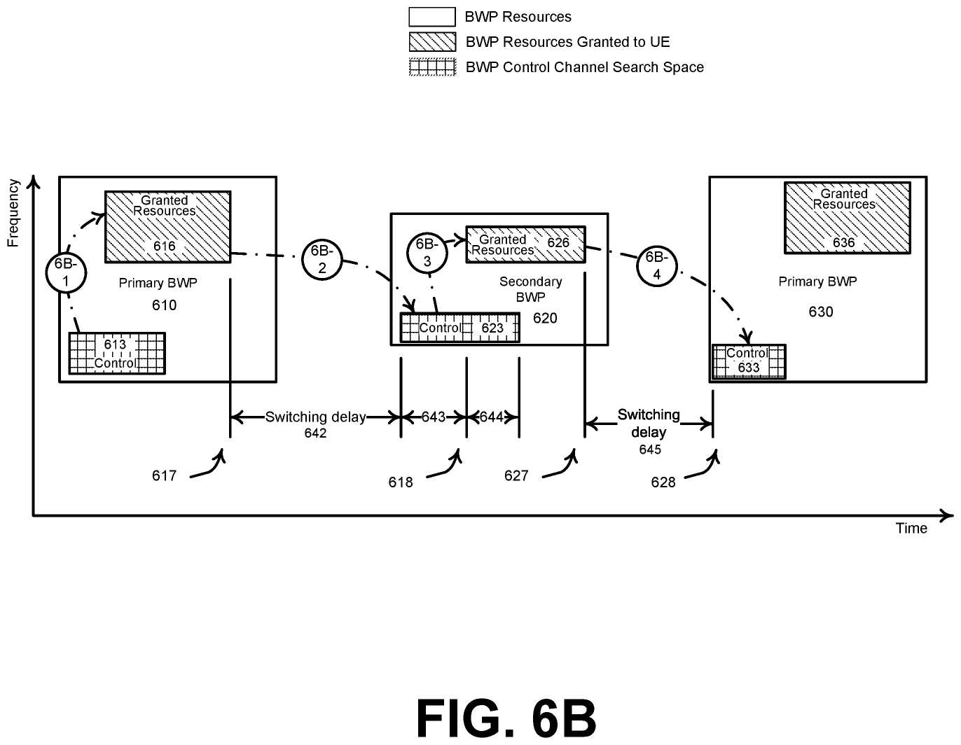

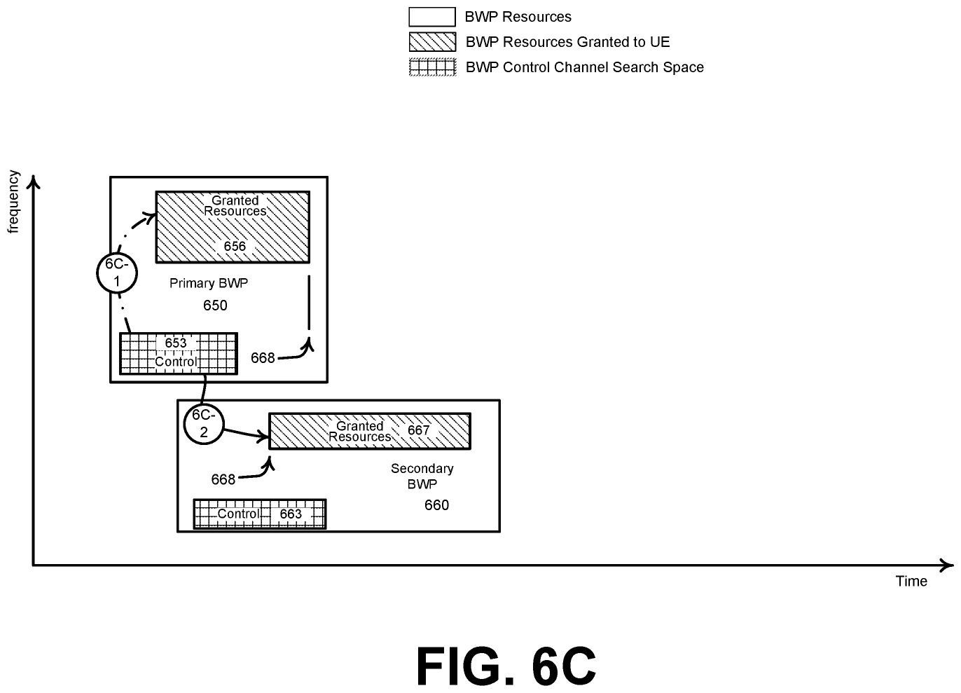

Turning now to FIG. 6A, an embodiment with a UE having a single RF chain is illustrated. With a UE having a single RF chain available for receiving data (either because the UE only has one RF chain or because a multi-chain UE has all other RF chains occupied with other tasks), BWP switching occurs in a manner that is non-overlapping with respect to time.

Thus, for a single-available RF chain, the RF chain is tuned according to only one BWP at a time.

In the embodiment shown in FIG. 6A, a UE may be configured, for example by a configuration 400 shown in FIG. 4, to receive a critical flow having a particular QoS via resources 616 corresponding to primary BWP 610 based on scheduling grant information provided, via control channel 613. Indication of scheduled resource grans may be provided via a configuration message 500 shown in FIG. 5. Continuing with description of FIG. 6A, control channel 613 of primary BWP 610 may comprise resource scheduling information and associated transmission configurations of secondary BWP 620, to be used for one or more other flows that may correspond to different QoS criterion/criteria than are configured for BWP 610. A user equipment configured for bandwidth parts 610, 620, and 630 shown in FIG. 6A may, at act 6A-1, receive downlink flows that have been configured to be associated with primary BWP 310. Flows received via BWP 610 may be associated with a stringent QoS. Primary BWP 630 is illustrated with a different reference number than primary BWP 610 because a control channel resource or granted resource may differ between the two, but it will be appreciated that BWP 610 and BWP 630 may refer to the same BWP in terms of frequency/spectrum range.

The UE may be configured to receive a flow having a stringent QoS via primary BWP 610, and may be configured to trigger, at act 6A-2, BWP switching to secondary BWP 620 to corresponding to a scheduled start time of scheduled resources 626 without switching to BWP 620 and decoding control channel 623 of the secondary BWP. Switching delay 619 may result and a UE may not be able to receive traffic between end 617 of resource 616 and the start 618 of resources 626. Accordingly, a UE may receive best effort traffic flow via secondary BWP 620 using radio configurations (e.g., subcarrier spacing, MIMO, etc.) corresponding to BWP 620 after receiving traffic requiring a higher, or different, QoS via radio configurations corresponding to BWP 310. It will be appreciated switching delay 619, although a delay, may nevertheless be a shorter delay then if the user equipment were configured to decode control channel 623 to determine granted resources 626 instead of granted resources 626 being configured via control channel 613 of BWP 610. Such a shortened switching delay may result because control channel 623 may have included information needed to decode, or determine, granted resources 626 near the end of control channel 623 during period 629. Thus, by scheduling resources 626 via control channel 613 instead of via control channel 623, switching delay 619 may be reduced by period 629. (The benefit of the reduced switching time is in addition to the benefit of not having to use power and processing resources at the user equipment blindly decode control channel resource(s) 623.)

A UE may be configured, for example, via control information contained in control channel 613, to revert to radio configuration corresponding to BWP 330 at act 6A-3 after resources 626 are scheduled to end at time 627 and to begin operation, for example, decoding control channel 633 at time 628, thus resulting in switching delay 639. Control channel 633 may comprise scheduling information corresponding to granted resources 636.

As shown in FIG. 6B, at act 6B-1, a user equipment may monitor and decode a control channel resource 613 of primary BWP 610 to determine resources 615 to be used to receive a flow according to BWP 610. At act 6B-2, the user equipment may adjust radio tuning to monitor and blindly decode control channel 623 to determine at act 6B-3 resources 626 to use to receive traffic of a different flow but of a same communication session as a flow received according to BWP 610. By configuring the user equipment to blindly decode control channel 623 as shown in FIG. 6B (instead of being configured to receive a flow according to resources 626 via control channel 613 as described in reference to FIG. 6A), a user equipment can use existing control channel format techniques wherein primary BWP control channel 613 in the embodiment shown in FIG. 6B may comprise scheduling information corresponding to primary BWP 610 and a switching indication (e.g., an indication to switch at end 617 of resources 616 and to revert back at end 627 of resources 626) corresponding to secondary BWP 620, but may not comprise an indication of resources 626. Thus, a user equipment may not be able to receive traffic according to resources 626 during switching delay 642 or during period 643 that starts after switching delay 642 and ends at the beginning 618 of resources 626.

A user equipment may be configured to revert back, at act 6B-4, to monitoring and decoding control channel 633 after receiving traffic of a given communication session according to secondary BWP 620 and after switching delay 645. The user equipment may begin receiving traffic according to BWP 630 via resources 636 after decoding control channel 633. Thus, unlike existing BWP switching techniques, according to which switching is either triggered by an explicit indication from a RAN node or is triggered by expiration of a defined timer, for example, BWP switching according to embodiments disclosed herein may be configured to automatically occur at time 627 at the end of scheduled secondary resources 626. User equipment receiving larger payloads over a longer period of scheduled resources 626 may take longer to switch back to primary BWP 610 than when receiving a small amount of payload (e.g., scheduling of resources 626 results in a longer time between 617 and 628), which may be referred to as device-specific triggered BWP switching.

FIG. 6C illustrates use of configured bandwidth parts by a user equipment comprising at least two RF chains for receiving traffic. A user equipment may be configured to monitor control channel 653 at act 6C-1 to determine resources 656 to be used to receive traffic of a given communication session having a certain QoS and, based on the monitoring of control channel 653 may determine resources 667 grated for use according to BWP 660 to receive traffic of a different flow and QoS of the same communication session without waiting until the end 668 of resources 656 to switch radio configuration to receive traffic according to resources 667. As compared to the embodiments disclosed in FIGS. 6A and 6B, the embodiment shown in FIG. 6C does not impose switching delay in switching from receiving traffic of a communication session from BWP 650 to BWP because the user equipment can be tuned to receive traffic according to resources 656 and resources 667 simultaneously.

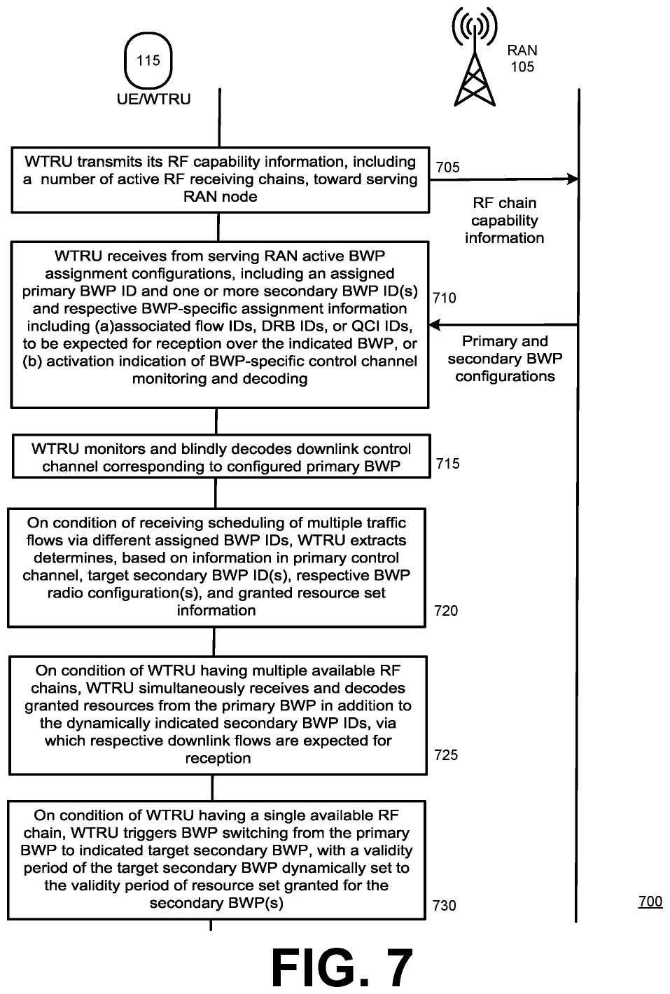

Turning now to FIG. 7, the figure illustrates a timing diagram of an example method 700. At act 705, UE 115 may transmit RF capability information corresponding to the UE towards serving RAN node 105. The RF information may comprise a number of active RF receiving chains available at the UE. At act 710, UE 115 may receive active BWP assignment configurations, such as configuration message 400 or DCI format 500 described in reference to FIGS. 4 and 5, respectively, from serving RAN node 105. A configuration received at act 710 may comprise an assignment of a primary BWP identifier and one or more identifier(s) corresponding to one or more secondary BWP(s), and respective BWP-specific assignment information that may comprise: (a) associated flow IDs, DRB IDs, or QCI IDs, to be expected for reception over the corresponding indicated BWP; or (b) activation indication of BWP-specific control channel monitoring and decoding. At act 715, UE 115 may monitor and blindly decode the downlink control channel of the configured primary BWP assigned via the configuration received at act 710. On condition of receiving multi flow traffic scheduling information corresponding to different assigned BWP IDs, UE 115 may, at act 720, extract and determine a secondary BWP ID and corresponding BWP radio configurations and granted resource set information to be used to receive traffic of a communication session for which the primary BWP is also being used. On condition of UE 115 comprising multiple available RF chains, the UE may, at act 725, simultaneously receive and decode granted resources from the primary BWP in addition to the dynamically indicated secondary BWP via which respective downlink flows are expected for reception. Alternatively, on condition of UE 115 having a single available RF chain, the UE may trigger, at act 730, BWP switching from the primary to an indicated secondary BWP to receive traffic of a different traffic flow having a different Qos during a period corresponding to a dynamically configured validity period of the granted resource set corresponding to the secondary BWP. Thus, the user equipment may potentially avoid having to blindly decode a control channel of the secondary BWP and also potentially avoid having to decode a control channel of the primary BWP when reverting back thereto after having received traffic according to the secondary BWP during the configured validity period of the scheduled resource set thereof.

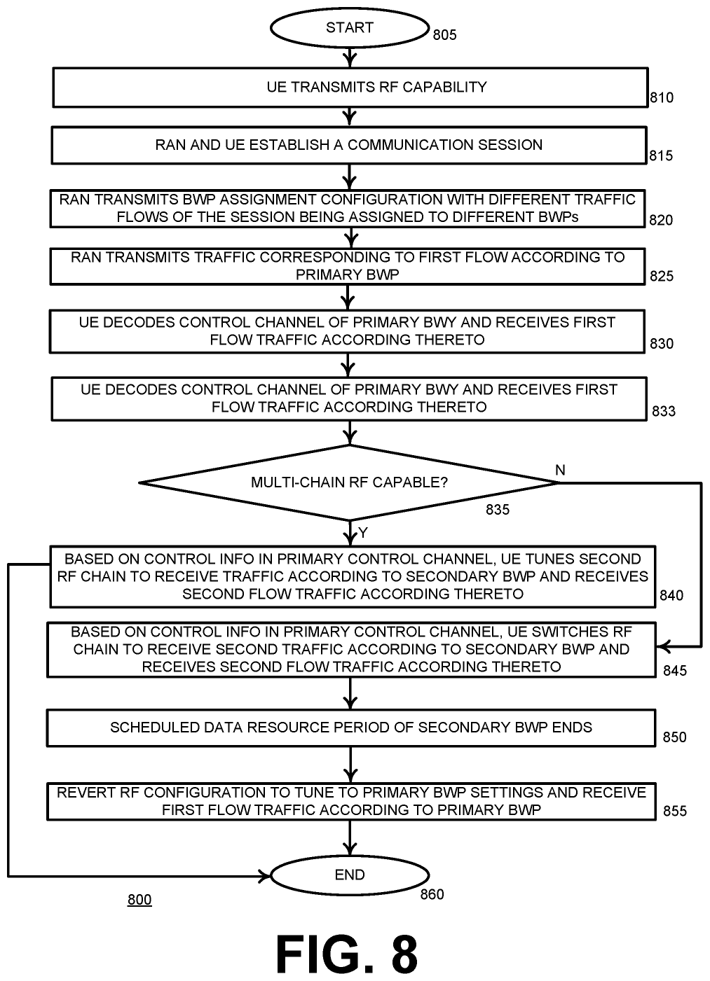

Turning now to FIG. 8, the figure illustrates a flow diagram of an example method 800. Method 800 begins at act 805. At act 810, a user equipment may transmit, and a radio access network node may receive, an indication of RF capability of the user equipment. For example, the indication of RF capability may comprise an indication indicative to the radio access network mode that the user equipment has multiple RF chains, and thus may be capable of simultaneously receiving different traffic flows according to respectively different bandwidth parts. At act 815, the radio access network node and the user equipment may establish a communication session. The communication session established at act 815 may comprise a first traffic flow and a second traffic flow.

At act 820, the radio access network node may transmit a bandwidth part assignment configuration to the user equipment. The bandwidth part assignment configuration may be transmitted as a radio resource control signal message or as a downlink control information message. The bandwidth part assignment configuration may comprise indications of a primary bandwidth part and a secondary bandwidth part and indications that the first traffic flow is to be received by the user equipment according to the primary bandwidth part and that the second traffic flow is to be received by the user equipment according to the secondary bandwidth part.

At act 825, the radio access network node may transmit traffic of the first flow according to the primary bandwidth part. At act 830, the user equipment may decode a control channel of the primary bandwidth part and receive packets of the first traffic flow according to a data resource corresponding to the primary bandwidth part, which may have been indicated via a control channel of the primary bandwidth part. At act 833, the radio access network node may transmit traffic of the second flow according to the secondary bandwidth part. If the user equipment is capable of simultaneously receiving two different traffic flows according to two different bandwidth part resources, based on control information that may have been contained in the control channel of the primary bandwidth part the user equipment may, at act 840, tune a second radio frequency chain, or a different radio frequency chain than used to receive traffic of the first traffic flow at act 830, to receive traffic according to the secondary bandwidth part, and receive traffic of the second traffic flow according to the second bandwidth part. For example, a multi-chain capable user equipment may tune a first radio frequency chain to receive packets of the first traffic flow according to a first frequency, a first subcarrier spacing, a first antenna configuration, and the like, corresponding to the first bandwidth part, and the user equipment may tune a second radio frequency chain to receive packets of the second traffic flow according to a second frequency, a second subcarrier spacing, or a second antenna configuration, and the like, according to the second bandwidth part. Method 800 advances to act 860 and ends.

Returning to description of act 835, if the user equipment is not multi-RF-chain capable, as indicated to the radio access network node at act 810, at act 845, the user equipment may switch a radio frequency receiver to receive traffic corresponding to the second traffic flow transmitted at act 833. The switching of the radio frequency receiver from being able to receive the first traffic flow according to the first bandwidth part to being able to receive the second traffic flow according to the second bandwidth part may have been indicated in a control channel corresponding to the primary bandwidth part. In an embodiment, the configuration transmitted from the radio access network node to the user equipment at act 820 may comprise timing, frequency, or other resources to be used to receive traffic of the second traffic flow according to the second bandwidth part such that the user equipment does not have to decode a control channel to determine the resources of the second bandwidth part to be used to receive traffic of the second flow.

Upon expiration at act 850 of a secondary bandwidth part data resource used by the user equipment to receive traffic of the second traffic flow, at act 855, the user equipment may revert radio frequency receiver settings from settings corresponding to receiving of traffic of the second traffic flow according to the secondary bandwidth part back to receiver settings corresponding to receiving traffic according to the primary bandwidth part. Method advances to act 860 and ends.

A bandwidth part assignment configuration transmitted at act 820 may facilitate the user equipment switching from receiving traffic according to the secondary bandwidth part to receiving traffic according to the first bandwidth part upon expiration of a schedule data resource of the secondary bandwidth without the user equipment having to monitor and decode a control channel before the switching of radio frequency receiver configuration. Thus, based on receiving a radio frequency capability indication from the user equipment at act 810, the radio access network node may generate the assignment configuration transmitted at act 820 such that the user equipment may only need to blindly decode a control channel of the first bandwidth part to not only determine resources corresponding to the second bandwidth part to be used to receive traffic of the second traffic flow but also to determine when to switch a radio frequency receiver configuration back to a configuration that facilitates receiving traffic according to the first bandwidth part.

In an embodiment, if traffic of the second traffic flow tends to be received at the radio access network node generally periodically, the radio access network node may configure the user equipment to change, or switch, bandwidth part resource arrangement configurations according to the periodicity at which the traffic of the second traffic flow may be received or transmitted by the radio access network node.

In an embodiment, control information in a control channel corresponding to the first bandwidth part may be indicative to the user equipment to decode a control channel of the secondary bandwidth part such that the user equipment may use conventional decoding of a control channel of the secondary bandwidth part to determine data resources to be used to receive traffic corresponding to the second traffic flow. Thus, even though the user equipment may blindly decode control channel information corresponding to the second bandwidth part to determine resources to be used of the second bandwidth part, control information in the control channel of the primary bandwidth part may be indicative of when the user equipment should switch from a radio frequency configuration according to the first bandwidth part to a radio frequency configuration according the second bandwidth part.

In an embodiment, control information in the control channel corresponding to the first bandwidth part may comprise an indication of data resources of the secondary bandwidth part to be used to receive traffic of the second traffic flow, thus facilitating the user equipment in avoiding blindly decoding a control channel of the secondary bandwidth part. For example, a ‘0’ transmitted in cell 510E of DCI format 500 described in reference to FIG. 5 may indicate to the user equipment resources 510C to be used to receive traffic of a secondary bandwidth part corresponding to secondary bandwidth part identifier 520 without the user equipment having to decode a control channel of the secondary bandwidth part.

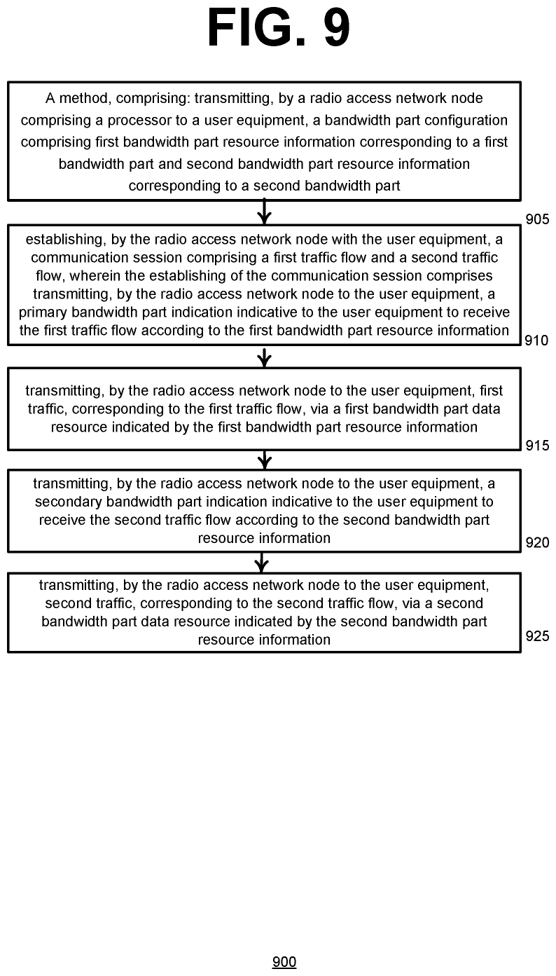

Turning now to FIG. 9, the figure illustrates an example embodiment method 900 comprising at block 905 transmitting, by a radio access network node comprising a processor to a user equipment, a bandwidth part configuration comprising first bandwidth part resource information corresponding to a first bandwidth part and second bandwidth part resource information corresponding to a second bandwidth part; at block 910 establishing, by the radio access network node with the user equipment, a communication session comprising a first traffic flow and a second traffic flow, wherein the establishing of the communication session comprises transmitting, by the radio access network node to the user equipment, a primary bandwidth part indication indicative to the user equipment to receive the first traffic flow according to the first bandwidth part resource information; at block 915 transmitting, by the radio access network node to the user equipment, first traffic, corresponding to the first traffic flow, via a first bandwidth part data resource indicated by the first bandwidth part resource information; at block 920 transmitting, by the radio access network node to the user equipment, a secondary bandwidth part indication indicative to the user equipment to receive the second traffic flow according to the second bandwidth part resource information; and at block 925 transmitting, by the radio access network node to the user equipment, second traffic, corresponding to the second traffic flow, via a second bandwidth part data resource indicated by the second bandwidth part resource information.

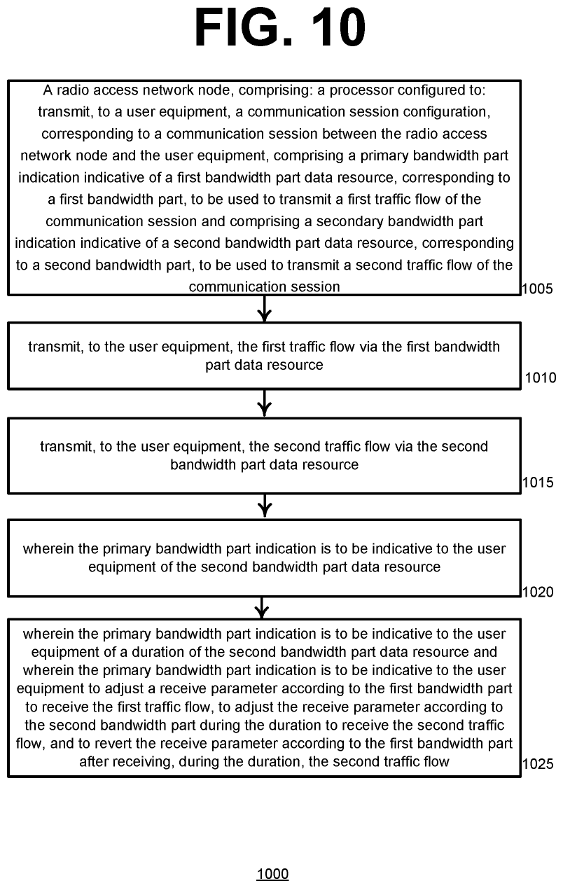

Turning now to FIG. 10, the figure illustrates an example radio access network node, comprising at block 1005 a processor configured to transmit, to a user equipment, a communication session configuration, corresponding to a communication session between the radio access network node and the user equipment, comprising a primary bandwidth part indication indicative of a first bandwidth part data resource, corresponding to a first bandwidth part, to be used to transmit a first traffic flow of the communication session and comprising a secondary bandwidth part indication indicative of a second bandwidth part data resource, corresponding to a second bandwidth part, to be used to transmit a second traffic flow of the communication session; at block 1010 transmit, to the user equipment, the first traffic flow via the first bandwidth part data resource; at block 1015 transmit, to the user equipment, the second traffic flow via the second bandwidth part data resource; at block 1020 wherein the primary bandwidth part indication is to be indicative to the user equipment of the second bandwidth part data resource; and at block 1025 wherein the primary bandwidth part indication is to be indicative to the user equipment of a duration of the second bandwidth part data resource and wherein the primary bandwidth part indication is to be indicative to the user equipment to adjust a receive parameter according to the first bandwidth part to receive the first traffic flow, to adjust the receive parameter according to the second bandwidth part during the duration to receive the second traffic flow, and to revert the receive parameter according to the first bandwidth part after receiving, during the duration, the second traffic flow.

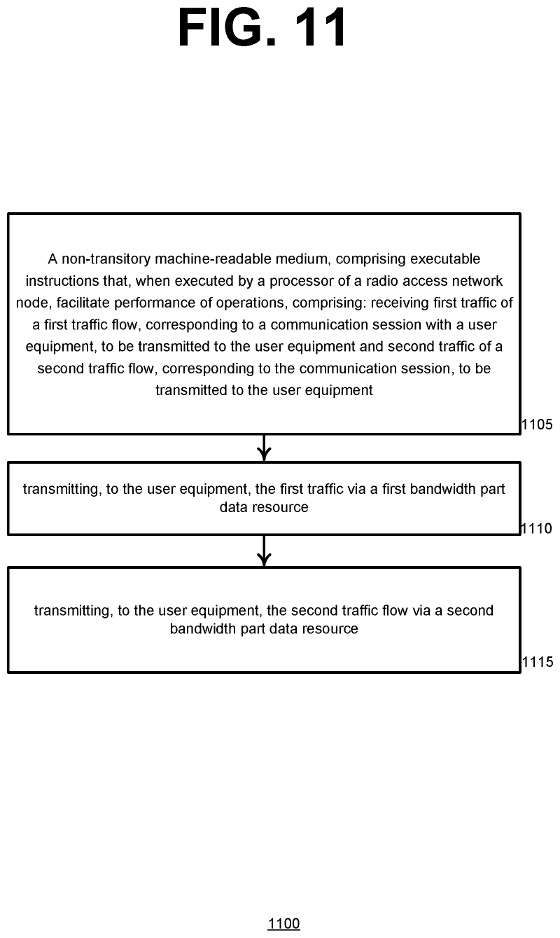

Turning now to FIG. 11, the figure illustrates a non-transitory machine-readable medium 1100 comprising at block 1105 executable instructions that, when executed by a processor of a radio access network node, facilitate performance of operations, comprising receiving first traffic of a first traffic flow, corresponding to a communication session with a user equipment, to be transmitted to the user equipment and second traffic of a second traffic flow, corresponding to the communication session, to be transmitted to the user equipment; at block 1110 transmitting, to the user equipment, the first traffic via a first bandwidth part data resource; and at block 1115 transmitting, to the user equipment, the second traffic flow via a second bandwidth part data resource.

In order to provide additional context for various embodiments described herein, FIG. 12 and the following discussion are intended to provide a brief, general description of a suitable computing environment 1200 in which various embodiments of the embodiment described herein can be implemented. While embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various embodiments described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors and may include a cache memory. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

Computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid-state drive (SSD) could be used in addition to, or in place of, an HDD 1210. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the.NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can comprise a security module, such as a trusted processing module (TPM). For instance, with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can be also connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are examples and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

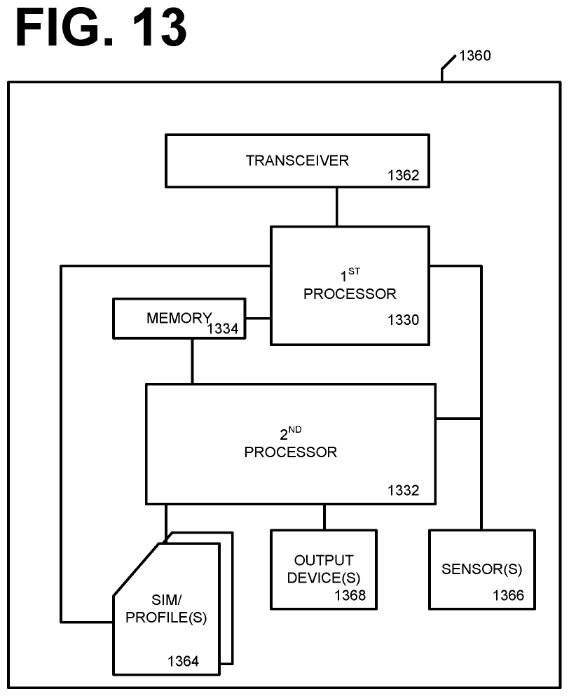

Turning now to FIG. 13, the figure illustrates a block diagram of an example UE 1360. UE 1360 may comprise a smart phone, a wireless tablet, a laptop computer with wireless capability, a wearable device, a machine device that may facilitate vehicle telematics, and the like. UE 1360 comprises a first processor 1330, a second processor 1332, and a shared memory 1334. UE 1360 includes radio front end circuitry 1362, which may be referred to herein as a transceiver, but is understood to typically include transceiver circuitry, separate filters, and separate antennas for facilitating transmission and receiving of signals over a wireless link, such as one or more wireless links 125, 135, or 137 shown in FIG. 1. Furthermore, transceiver 1362 may comprise multiple sets of circuitry or may be tunable to accommodate different frequency ranges, different modulations schemes, or different communication protocols, to facilitate long-range wireless links such as links, device-to-device links, such as links 135, and short-range wireless links, such as links 137.

Continuing with description of FIG. 13, UE 1360 may also include a SIM 1364, or a SIM profile, which may comprise information stored in a memory (memory 34 or a separate memory portion), for facilitating wireless communication with RAN 105 or core network 130 shown in FIG. 1. FIG. 13 shows SIM 1364 as a single component in the shape of a conventional SIM card, but it will be appreciated that SIM 1364 may represent multiple SIM cards, multiple SIM profiles, or multiple eSIMs, some or all of which may be implemented in hardware or software. It will be appreciated that a SIM profile may comprise information such as security credentials (e.g., encryption keys, values that may be used to generate encryption keys, or shared values that are shared between SIM 1364 and another device, which may be a component of RAN 105 or core network 130 shown in FIG. 1). A SIM profile 1364 may also comprise identifying information that is unique to the SIM, or SIM profile, such as, for example, an International Mobile Subscriber Identity (“IMSI”) or information that may make up an IMSI.

SIM 1364 is shown coupled to both the first processor portion 1330 and the second processor portion 1332. Such an implementation may provide an advantage that first processor portion 30 may not need to request or receive information or data from SIM 1364 that second processor 1332 may request, thus eliminating the use of the first processor acting as a ‘go-between’ when the second processor uses information from the SIM in performing its functions and in executing applications. First processor 1330, which may be a modem processor or baseband processor, is shown smaller than processor 1332, which may be a more sophisticated application processor, to visually indicate the relative levels of sophistication (i.e., processing capability and performance) and corresponding relative levels of operating power consumption levels between the two processor portions. Keeping the second processor portion 1332 asleep/inactive/in a low power state when UE 1360 does not need it for executing applications and processing data related to an application provides an advantage of reducing power consumption when the UE only needs to use the first processor portion 1330 while in listening mode for monitoring routine configured bearer management and mobility management/maintenance procedures, or for monitoring search spaces that the UE has been configured to monitor while the second processor portion remains inactive/asleep.

UE 1360 may also include sensors 1366, such as, for example, temperature sensors, accelerometers, gyroscopes, barometers, moisture sensors, and the like that may provide signals to the first processor 1330 or second processor 1332. Output devices 1368 may comprise, for example, one or more visual displays (e.g., computer monitors, VR appliances, and the like), acoustic transducers, such as speakers or microphones, vibration components, and the like. Output devices 1368 may comprise software that interfaces with output devices, for example, visual displays, speakers, microphones, touch sensation devices, smell or taste devices, and the like, that are external to UE 1360.

The following glossary of terms given in Table 1 may apply to one or more descriptions of embodiments disclosed herein.

TABLE 1

| Term | Definition |
|---|---|
| UE | User equipment |
| WTRU | Wireless transmit receive unit |
| RAN | Radio access network |
| QoS | Quality of service |
| DRX | Discontinuous reception |
| EPI | Early paging indication |
| DCI | Downlink control information |
| SSB | Synchronization signal block |
| RS | Reference signal |
| PDCCH | Physical downlink control channel |
| PDSCH | Physical downlink shared channel |
| MUSIM | Multi-SIM UE |
| SIB | System information block |
| MIB | Master information block |
| eMBB | Enhanced mobile broadband |
| URLLC | Ultra reliable and low latency communications |
| mMTC | Massive machine type communications |
| XR | Anything-reality |
| VR | Virtual reality |
| AR | Augmented reality |
| MR | Mixed reality |
| DCI | Downlink control information |
| DMRS | Demodulation reference signals |
| QPSK | Quadrature Phase Shift Keying |
| WUS | Wake up signal |
| HARQ | Hybrid automatic repeat request |
| RRC | Radio resource control |
| C-RNTI | Connected mode radio network temporary identifier |
| CRC | Cyclic redundancy check |
| MIMO | Multi input multi output |
| UE | User equipment |
| CBR | Channel busy ratio |
| SCI | Sidelink control information |
| SBFD | Sub-band full duplex |
| CLI | Cross link interference |
| TDD | Time division duplexing |
| FDD | Frequency division duplexing |
| BS | Base-station |
| RS | Reference signal |
| CSI-RS | Channel state information reference signal |
| PTRS | Phase tracking reference signal |
| DMRS | Demodulation reference signal |
| gNB | General NodeB |
| PUCCH | Physical uplink control channel |
| PUSCH | Physical uplink shared channel |
| SRS | Sounding reference signal |
| NES | Network energy saving |
| QCI | Quality class indication |
| RSRP | Reference signal received power |
| PCI | Primary cell ID |
| BWP | Bandwidth Part |

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” or variations thereof as may be used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
transmitting, by a radio access network node comprising a processor to a user equipment, a bandwidth part configuration comprising first bandwidth part resource information corresponding to a first bandwidth part and second bandwidth part resource information corresponding to a second bandwidth part;
establishing, by the radio access network node with the user equipment, a communication session comprising a first traffic flow and a second traffic flow, wherein the establishing of the communication session comprises transmitting, by the radio access network node to the user equipment, a primary bandwidth part indication indicative to the user equipment to receive the first traffic flow according to the first bandwidth part resource information;
transmitting, by the radio access network node to the user equipment, first traffic, corresponding to the first traffic flow, via a first bandwidth part data resource indicated by the first bandwidth part resource information;
transmitting, by the radio access network node to the user equipment, a secondary bandwidth part indication indicative to the user equipment to receive the second traffic flow according to the second bandwidth part resource information; and
transmitting, by the radio access network node to the user equipment, second traffic, corresponding to the second traffic flow, via a second bandwidth part data resource indicated by the second bandwidth part resource information.

2. The method of claim 1, wherein the establishing of the communication session further comprises transmitting, by the radio access network node to the user equipment, the secondary bandwidth part indication.

3. The method of claim 2, wherein the second bandwidth part resource information comprises a second bandwidth part control channel indication indicative to the user equipment of a second control channel resource corresponding to the second bandwidth part to be used to obtain control information corresponding to the second bandwidth part.

4. The method of claim 1, wherein the first bandwidth part resource information comprises a first bandwidth part control channel indication indicative to the user equipment of a first control channel resource corresponding to the first bandwidth part to be used to obtain control information corresponding to the first bandwidth part.

5. The method of claim 4, wherein the control information corresponding to the first bandwidth part is indicative to the user equipment of the second bandwidth part data resource.

6. The method of claim 5, wherein the second bandwidth part data resource corresponds to an expiration time, wherein the first bandwidth part control channel indication is indicative to the user equipment to receive traffic according to the first bandwidth part data resource after the expiration time.

7. The method of claim 4, wherein the control information corresponding to the first bandwidth part is indicative to the user equipment of the second bandwidth part data resource, wherein the user equipment comprises first radio frequency circuitry and second radio frequency circuitry, wherein the radio access network node simultaneously transmits the first traffic via the first bandwidth part data resource and the second traffic via the second bandwidth part data resource.

8. The method of claim 1, wherein the primary bandwidth part indication and the secondary bandwidth part indication are transmitted via a downlink control information format indication message.

9. The method of claim 8, wherein the primary bandwidth part indication and the secondary bandwidth part indication are indicative of at least one of a scheduled first control channel resource corresponding to the first bandwidth part or a scheduled second control channel resource corresponding to the second bandwidth part.

10. The method of claim 1, wherein the first traffic flow corresponds to a first quality-of-service, wherein the second traffic flow corresponds to a second quality-of-service, wherein the communication session comprises a third traffic flow corresponding to the second quality-of-service, and wherein the secondary bandwidth part indication is indicative to the user equipment to receive the third traffic flow according to the second bandwidth part resource information.

11. The method of claim 1, wherein arrival of protocol data units of the second traffic flow at the radio access network node is periodic in nature and corresponds to a periodicity, and wherein the secondary bandwidth part indication is indicative to the user equipment to switch from a first receive configuration used to receve the first traffic flow via the first bandwidth part data resource to a second receive configuation to receive the second traffic flow via the second bandwidth part data resource according to the periodicity.

12. The method of claim 1, wherein the first traffic flow corresponds to a first quality-of-service, wherein the second traffic flow corresponds to a second quality-of-service, wherein the first bandwidth part corresponds to the first quality-of-service, and wherein the second bandwidth part corresponds to the second quality-of-service,
the method further comprising:
determining, based on the first traffic flow corresponding to the first quality-of-service, to transmit the first traffic flow via the first bandwidth part data resource; and
determining, based on the second traffic flow corresponding to the second quality-of-service, to transmit the second traffic flow via the second bandwidth part data resource.

13. A radio access network node, comprising:
a processor configured to:
transmit, to a user equipment, a communication session configuration, corresponding to a communication session between the radio access network node and the user equipment, comprising a primary bandwidth part indication indicative of a first bandwidth part data resource, corresponding to a first bandwidth part, to be used to transmit a first traffic flow of the communication session and comprising a secondary bandwidth part indication indicative of a second bandwidth part data resource, corresponding to a second bandwidth part, to be used to transmit a second traffic flow of the communication session;
transmit, to the user equipment, the first traffic flow via the first bandwidth part data resource; and
transmit, to the user equipment, the second traffic flow via the second bandwidth part data resource.

14. The radio access network node of claim 13, wherein the primary bandwidth part indication is to be indicative to the user equipment of a control channel resource corresponding to the second bandwidth part to be used to obtain control information corresponding to the second bandwidth part.

15. The radio access network node of claim 13, wherein the primary bandwidth part indication is to be indicative to the user equipment of the second bandwidth part data resource.

16. The radio access network node of claim 15, wherein the primary bandwidth part indication is to be indicative to the user equipment of a duration of the second bandwidth part data resource and wherein the primary bandwidth part indication is to be indicative to the user equipment to adjust a receive parameter according to the first bandwidth part to receive the first traffic flow, to adjust the receive parameter according to the second bandwidth part during the duration to receive the second traffic flow, and to revert the receive parameter according to the first bandwidth part after receiving, during the duration, the second traffic flow.

17. A non-transitory machine-readable medium, comprising executable instructions that, when executed by a processor of a radio access network node, facilitate performance of operations, comprising:
receiving first traffic of a first traffic flow, corresponding to a communication session with a user equipment, to be transmitted to the user equipment and second traffic of a second traffic flow, corresponding to the communication session, to be transmitted to the user equipment;
transmitting, to the user equipment, the first traffic via a first bandwidth part data resource; and
transmitting, to the user equipment, the second traffic flow via a second bandwidth part data resource.

18. The non-transitory machine-readable medium of claim 17, the operations further comprising:
transmitting, to the user equipment, a communication session configuration, corresponding to the communication session, comprising a primary bandwidth part indication indicative of the first bandwidth part data resource and a secondary bandwidth part indication indicative of the second bandwidth part data resource,
wherein the primary bandwidth part indication is indicative of a start time of the second bandwidth part data resource.

19. The non-transitory machine-readable medium of claim 17, the operations further comprising:
transmitting, to the user equipment, a communication session configuration, corresponding to the communication session, comprising a primary bandwidth part indication indicative of the first bandwidth part data resource and a secondary bandwidth part indication indicative of the second bandwidth part data resource,
wherein the primary bandwidth part indication is indicative of a control channel resource corresponding to the second bandwidth part to be used to obtain control information corresponding to the second bandwidth part.

20. The non-transitory machine-readable medium of claim 17, the operations further comprising:
transmitting, to the user equipment, a communication session configuration, corresponding to the communication session, comprising a primary bandwidth part indication indicative of the first bandwidth part data resource and a secondary bandwidth part indication indicative of the second bandwidth part data resource;
wherein the primary bandwidth part indication is indicative of a duration of the second bandwidth part data resource, wherein the primary bandwidth part indication is indicative to the user equipment to adjust a receive parameter according to the first bandwidth part to receive the first traffic flow, to adjust the receive parameter according to the second bandwidth part during the duration to receive the second traffic flow, and to revert the receive parameter according to the first bandwidth part after receiving, during the duration, the second traffic flow, and wherein the radio access network node transmits the second traffic flow during the duration of the second bandwidth part data resource.
